(19) United States
(12) Patent Application Publication
(10) Pub. No.: US 2010/0236168 A1
(43) Pub. Date: Sep. 23, 2010

(54) High Impact Storm Panel

(76) Inventor: Christopher B. Gosse, Ft. Pierce, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 12/405,725

(22) Filed: Mar. 17, 2009

(51) Int. Cl. E06B 1/04; E04B 1/35

(52) U.S. Cl. 52/213; 52/745.15

(57) ABSTRACT

A high impact panel and its method of installation for withstanding high winds and impacts from flying debris, including large debris, and particularly suited for use in violent storms such as hurricanes. The present inventive panel may be further incorporated into a high impact panel system to enclose and protect an opening on a building, such as a porch, or the system of the present invention may be used to form its own independent structure for temporary housing and the like. When protecting an opening of a preexisting structure, the present invention may be adapted to fit within the dimension of the opening of the structure and may incorporate and utilize already present support structures such as columns, posts, or poles. Additionally and as necessary, a door or other means of access may be incorporated into a high impact wall panel of the present invention.

### CROSS REFERENCE TO RELATED APPLICATIONS

Not applicable.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to window panel construction and methods of installation, more specifically, the present invention relates to window panel constructions capable of withstanding high impacts from flying debris, including large debris, and particularly suited for use in violent storms such as hurricanes.

2. Background Art

Weather is a major cause of extreme damage and human injury. Hurricanes and tropical storms, prolific on the east coast and gulf coast of the United States, particularly in Florida, are examples of weather occurrences that wreck havoc with buildings. Many building codes, particularly in hurricane-prone areas, require that doors and windows in habitable structures meet strict structural design parameters. The structural integrity of doors, windows, porches, and exterior cladding elements is strictly governed by these codes.

New code requirements, especially in south Florida, have generated a rapidly growing industry in hurricane-resistant building envelopes and components.

There are several main performance criteria directed to doors and windows, for example “impact resistance,” “structural load capacity,” “cyclic resistance,” and “uniform static air pressure resistance”. Impact resistant performance criteria recognize the need for resistance to windborne debris, which can cause catastrophic damage when striking a door, window, or other exposed surface under structural load.

During severe storms, such as hurricanes, most of the damage to a building results from wind or wind-borne missiles that break windows and allow rain and wind into the building. Once the wind is inside a building, the resulting pressure can even lift the roof off the building. Temporary coverings or forms of permanent reinforcement are often placed over porches, windows, doors, and the like to reduce or prevent damage to the building during a hurricane or other violet storms.

During hurricane warnings, homeowners without permanent reinforcements often nail plywood over windows and glass doors to prevent wind-driven rain and debris from breaking the window and entering the house. Although plywood is an inexpensive material, it is difficult to nail to a home quickly. Nailing sheets of plywood to a home is time-consuming and cumbersome due to the weight of the material, and the need for assistance. Homeowners are often reluctant to drive nails into their window frames or do not want to be on a ladder during high winds. In addition, more than one person is typically required to hold up a large, heavy piece of plywood and simultaneously nail it into position. Further, strong winds may often rip nailed plywood from a window frame, and rain and winds may warp the plywood so that it cannot be reused for subsequent storms.

One alternative to installing either impact resistant or high wind resistant components into building openings has been to “shutter” the opening with structurally designed and approved devices that are physically placed over the opening prior to the high wind event. These shutter systems serve to increase resistance to impact from objects and to high pressures. However, because of the physical size of openings such as a garage door, the shutter systems may be cumbersome and expensive, and render such functional openings unusable while “shuttered.”

A number of protective coverings have been designed. U.S. Pat. No. 6,205,713 describes a shutter system that includes brackets above or below a window and sliding latches at the edges of the window. Transparent shutter systems are described in U.S. Pat. No. 4,685,261 and U.S. Pat. No. 5,228,238. An accordion fold shutter system is described in U.S. Pat. No. 5,522,445. In attempts to solve problems associated with securing buildings for an imminent storm, some devices have been developed to secure plywood panels without damaging the surrounding building structure. For example, U.S. Pat. Nos. 5,673,883, 6,330,768 and 6,371,422 all describe methods of retaining plywood boards over windows with bars for the sake of protecting the windows from storms without damaging the surrounding window frames.

However, there remains a need for a cost-effective, easy-to-use protective covering for porches, windows, and doors that is highly resistant to impact breakage, especially, during the bombardment of debris or other air-borne projectiles during severe storms, such as hurricanes.

Therefore, it is an aspect of the invention to provide a cost-effective, easy to use cover for protecting porches, windows, and doors during severe storms, such as hurricanes.

It is a further aspect of the invention to provide cost-effective and easy to use kits for protecting porches, windows, and doors during severe storms, such as hurricanes.

No reference in the prior art discloses a high impact panel system for securing a panel across a porch, window, glass door, and any other similar enclosure or opening, wherein the high impact panel system can be quickly installed and may be easily used to protect a variety of different sized enclosures or openings. To this end, there still exists a need in the art for a method and system for quickly and easily protecting porches, windows, glass doors, and the like against high winds and storm damage.

### BRIEF SUMMARY OF THE INVENTION

In accordance with one embodiment of the present invention, a high impact panel system for protecting an opening within a structure comprising an upper C-channel attached to the structure along the upper surface of the opening; a floor angle attached to the structure along the lower surface of the opening; at least one high impact panel, wherein an upper end of the at least one high impact panel is inserted within the upper C-channel and a lower end of the at least one high impact panel abuts the floor angle; and a locking angle attached to the structure along the lower surface of the opening and abutting against the lower end of the at least one high impact panel, wherein the locking angle retains the lower end of the at least one high impact panel between the floor angle and the locking angle.

The scope of the present invention further includes, a method of protecting an opening within a structure comprising the steps of attaching an upper C-channel to the structure along the upper surface of the opening; attaching a floor angle to the structure along the lower surface of the opening; inserting an upper end of at least one high impact panel within the upper C-channel; pivoting the upper end of the at least one high impact panel within the upper C-channel wherein a lower end of the at least one high impact panel abuts the floor angle; and attaching a locking angle to the structure along the lower surface of the opening and abutting against the lower end of the at least one high impact panel, wherein the locking angle retains the lower end of the at least one high impact panel between the floor angle and the locking angle.

### BRIEF DESCRIPTION OF THE DRAWINGS

A better understanding of the present invention will be realized from the detailed description that follows, taken in conjunction with the accompanying drawings, in which:

FIG. 1 depicts a front view of an embodiment of a high impact panel of the present invention.

FIG. 2 depicts a front view of an embodiment of a frame assembly of a high impact panel of the present invention.

FIG. 3 depicts a front view during construction of an embodiment of a frame assembly of a high impact panel of the present invention.

FIG. 4 also depicts a front view during construction of an embodiment of a frame assembly of a high impact panel of the present invention.

FIG. 5 depicts a top view of a window prior to its incorporation within a frame assembly of a high impact panel of the present invention.

FIG. 6 depicts a front view of a window installed within a frame assembly of a high impact panel of the present invention.

FIG. 7 depicts a side view of an embodiment of a kick plate region of a high impact panel of the present invention.

FIG. 8 depicts a side view of an embodiment of communication between an top angle and a second horizontal cross member of the kick plate region of the present invention.

FIG. 9 depicts a front view of an embodiment of a kick plate region of a high impact panel of the present invention.

FIG. 10 depicts a side view of an embodiment of a kick plate region of a high impact panel of the present invention.

FIG. 11 depicts a rear view of an embodiment of a kick plate region of a high impact panel of the present invention.

FIG. 12 depicts a side view of an embodiment of a kick plate region of a high impact panel of the present invention.

FIG. 13 depicts a rear view of an embodiment of a kick plate region of a high impact panel of the present invention.

FIG. 14 depicts a front view of an embodiment of three interconnected high impact panels of the present invention

FIG. 15 depicts a front view of an embodiment of a porch or other opening of a preexisting structure prior to installation of a high impact panel system of the present invention.

FIG. 16 depicts a front view of an embodiment of three interconnected high impact panels of the present invention.

FIG. 17 depicts a side view of the embodiment of FIG. 15 illustrating a porch or other opening of a preexisting structure prior to installation of a high impact panel system of the present invention.

FIG. 18 depicts a front view of an embodiment of the initial stage of installation of a high impact panel system of the present invention.

FIG. 19 depicts a side view of an embodiment of an upper C-channel of the high impact panel system of the present invention

FIG. 20 depicts a side view of an embodiment of a floor angle of the high impact panel system of the present invention.

FIG. 21 depicts a top view of an embodiment of a first side C-channel of the high impact panel system of the present invention.

FIG. 22 depicts a front view of an embodiment of a further stage of installation of a high impact panel system of the present invention.

FIG. 23 depicts a rear view of an embodiment of the floor angle of the high impact panel system of the present invention.

FIG. 24 depicts a front view of one embodiment of a high impact panel of the present invention.

FIG. 25 depicts a side view of an embodiment of a still further stage of installation of a high impact panel system of the present invention.

FIG. 26 depicts a side view of an embodiment of a still further stage of installation of a high impact panel system of the present invention.

FIG. 27 depicts a front view of an embodiment of a still further stage of installation of a high impact panel system of the present invention.

FIG. 28 depicts a front view of an embodiment of a still further stage of installation of a high impact panel system of the present invention.

FIG. 29 depicts a front view of an embodiment of a still further stage of installation of a high impact panel system of the present invention.

FIG. 30 depicts a side view of an embodiment of an locking angle of a high impact panel system of the present invention.

FIG. 31 depicts a front view of an embodiment of a still further stage of installation of a high impact panel system of the present invention.

### DETAILED DESCRIPTION OF THE INVENTION

At least one protective panel for porches, windows, and doors and kits containing at least one protective panel for porches, windows, and doors are described herein.

Although the following detailed description contains many specifics for the purposes of illustration, anyone of ordinary skill in the art will appreciate that many variations and alterations to the following details are within the scope of the invention. Any dimensions and measurements expressly discussed herein are used only for the purpose of additional clarity and understanding of at least one embodiment within the broad scope of the present invention. Accordingly, the following preferred embodiments of the invention are set forth without any loss of generality to, and without imposing limitations upon, the claimed invention.

### I. High Impact Panel

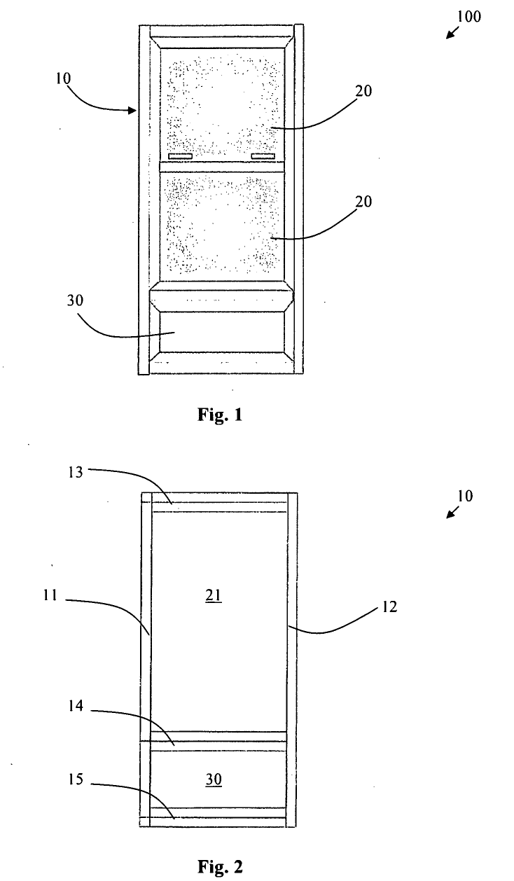

FIG. 1 illustrates one embodiment of a high impact panel 100 of the present invention. The high impact panel 100 may generally comprise a frame assembly 10, one or more windows 20, and a kick plate region 30. The high impact panel 100 may be manufactured in a wide variety of sizes and dimensions as needed for each respective construction project. Additionally, the high impact panel 100 may be modular in nature allowing for two or more high impact panels 100 to be interconnected and thereby provide protection from high winds and projectiles across a larger exposed surface area.

A high impact panel 100 of the present invention may be constructed via a variety of methods. One such method is disclosed below; however, one skilled in the art will fully appreciate alternate embodiments and variations known within the art to be functionally equivalent to the methods disclosed herein. As an example, all fasteners and means of attachment disclosed below may be freely substituted with any other fasteners and means of attachment known within the art.

In one embodiment of a method for constructing a high impact panel 100, an optional jig may be manufactured to assist in construction of a device of the present invention. In use, such an optional jig may act to keep the respective frame assembly 10 components in tight contact while such components are being secured together. In one embodiment, the optional jig may assist in manufacturing a standard 40 inch by 90 inch high impact panel 100.

As shown in FIG. 2, the respective components of the frame assembly 10 may comprise a first vertical stud 11 and a second vertical stud 12 between which a first horizontal cross member 13, a second horizontal cross member 14, and a third horizontal cross member 15 are disposed. The respective vertical studs 11,12 may be disposed perpendicular to each of the respective horizontal cross members 13-15 and serve to define a window opening 21 and kick plate region 30. In a preferred embodiment, each component of the frame assembly 10 may comprise 2 inch by 3 inch aluminum; however, the frame assembly 10 may comprise any other material known within the art. In an embodiment such as that depicted in FIG. 2, all points of contact between the vertical studs 11,12 and the horizontal cross members 13-15 may comprise a welded joint to provide a strong frame assembly 10. The welds may be performed on both the front and rear surface of the frame assembly 10 by flipping the frame assembly within the optional jig. All such welds may preferably be made using a continuous bead. To keep the welded joints clean and for aesthetic purposes, the manufacturer may grind, prime, and/or paint the frame assembly 10 and joints thereof.

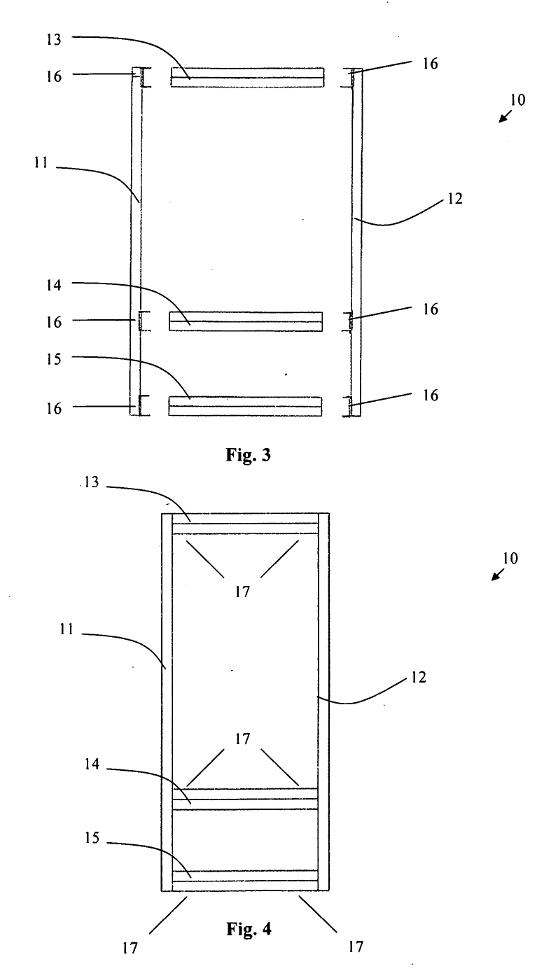

FIGS. 3-4 depict an alternate embodiment of constructing the frame assembly 10. As shown in FIG. 3, cross member brackets 16 may be attached to the respective inner surface of the first vertical stud 11 and second vertical stud 12 via fasteners 17. Fasteners 17 may comprises any form of attachment means know within the art including but not limited to screws, bolts, rivets, and the like. Within the scope of the present invention, fasteners 17 may be replaced by any means of fixation know within the art including but not limited to welded joints, chemical bonding, unitary construction, and the like. In a preferred embodiment, the fasteners 17 comprise stainless steel self-tapping screws that pass through pre-drilled holes within the cross member brackets 16 and thereafter may securely fasten the brackets 16 to the vertical studs 11,12. The cross member bracket 16 may comprise either U-shaped brackets or two L-shaped brackets that may be abutted against each other to provide the U-shaped side profile as shown in FIG. 3. Caulk, foam or a plastic insert for weather proofing may then be installed at each connection between the vertical studs 11,12 and the horizontal cross members 13-15. The horizontal cross members 13-15 may then be slid into position within the cross member brackets 16, with the horizontal cross member 13-15 being disposed perpendicular to the vertical studs 11,12. As depicted in FIG. 4, fasteners 17 may thereafter securely fix the horizontal cross member 13-15 to the cross member brackets 16. No fasteners 17 need be placed within the kick plate region 30 (see FIG. 1) due to further construction steps to be described below. The frame assembly 10 may then be inspected for any gaps or other small openings, wherein such openings may be filled with additional caulk, foam, or plastic inserts to weather proof the high impact panel 100 against high winds.

An alternate embodiment, the frame assembly 10 may comprise a manufactured one-piece cast unit thereby eliminating the above-mentioned steps of constructing the frame assembly 10.

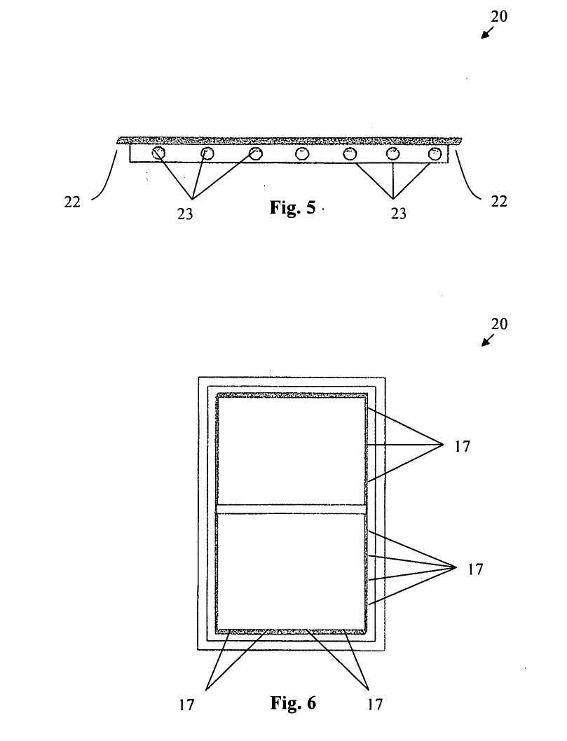

As shown in FIG. 5 and prior to the installation of one or more windows 20, caulk or foam may be dispensed along a continuous line on the underside of the flange 22 on all four sides of the window 20. Also depicted in FIG. 5, the majority of window manufacturers provide pre-drilled factory holes 23 for attaching the window 20 to the frame assembly 10 in which the window 20 is set. Next, the window 20 may be gently placed within the window opening 21 of the frame assembly 10. To secure the window 20 within the window opening 21, fasteners 17 may be disposed through each of the provided pre-drilled factory holes 23 and into the immediately adjacent vertical stud 11,12 or horizontal cross member 13,14. In a preferred embodiment, the fasteners 17 may comprise stainless steel screws being used along the top, bottom, and both sides of the window 20.

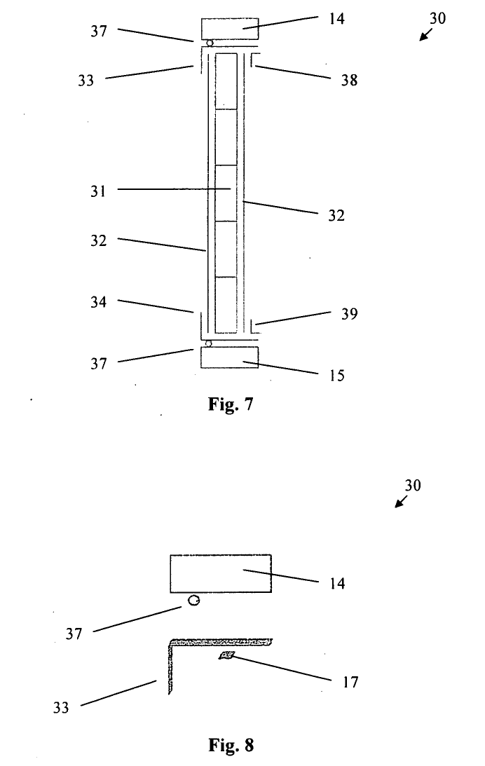

Construction of the kick plate region 30 of the high impact panel 100 may be accomplished in a manner highly similar to the second embodiment of construction of the frame assembly 10 that utilizes cross member brackets 16. FIG. 7 illustrates a side cross sectional view of one embodiment of the kick plate region 30. A continuous bead of caulk or foam 37 may be disposed about the respective inner surfaces of the vertical studs 11,12, second horizontal cross member 14, and third horizontal cross member 15. A top angle 33, a bottom angle 34, a first side angle 35, and a second side angle 36 may then be installed about the respective inner surfaces of the kick plate region 30 formed by vertical studs 11,12 and horizontal cross members 14,15. As shown in FIGS. 7-9, the angles 33-36 may have a continuous bead of caulk or foam 37 disposed on the outer surfaces of the angles 33-36 creating a seal about the kick plate region 30. As shown in FIG. 8, a plurality of fasteners 17 may then be used to secure each of the respective angles 33-36 into position by passing the fasteners 17 through the respective angles 33-36 and thereafter into the adjacent frame assembly 10 components.

In one embodiment as further shown in FIGS. 7 and 10, the kick plate region 30 may comprises a plurality of stacked cross members 31. In a preferred embodiment, the plurality of stacked cross members 31 may comprise five cross members vertically stacked with construction adhesive disposed between each adjacent cross member. In such a configuration, the plurality of stacked cross members 31 may be clamped together until the construction adhesive has been allowed to dry. Alternatively, the plurality of stacked cross member 31 may be secured together by any other means known within the art including but not limited to welded joints, a plurality of fasteners 17, and the like. The plurality of stacked cross members 31 may serve to provide an area through which electrical conduit, HVAC tubing, and/or plumbing may be run. For a more finished look, flat coil stock 32 or any other material known within the art may be cut and sized to cover the plurality of stacked cross member 31 and provide an aesthetic appearance to the kick plate region 30. The flat coil stock 32 or other material may be secured to the plurality of stacked cross members 31 via caulk or any other adhesive known within the art. In a preferred embodiment, the caulk or other adhesive may be applied to the four corners and/or center of the flat coil stock 32 as a means of retaining the flat coil stock 32 in position. In this manner and as shown in FIGS. 7 and 10, flat coil stock 32 or other like material may be disposed on the front and/or back surfaces of the plurality of stacked cross members 31.

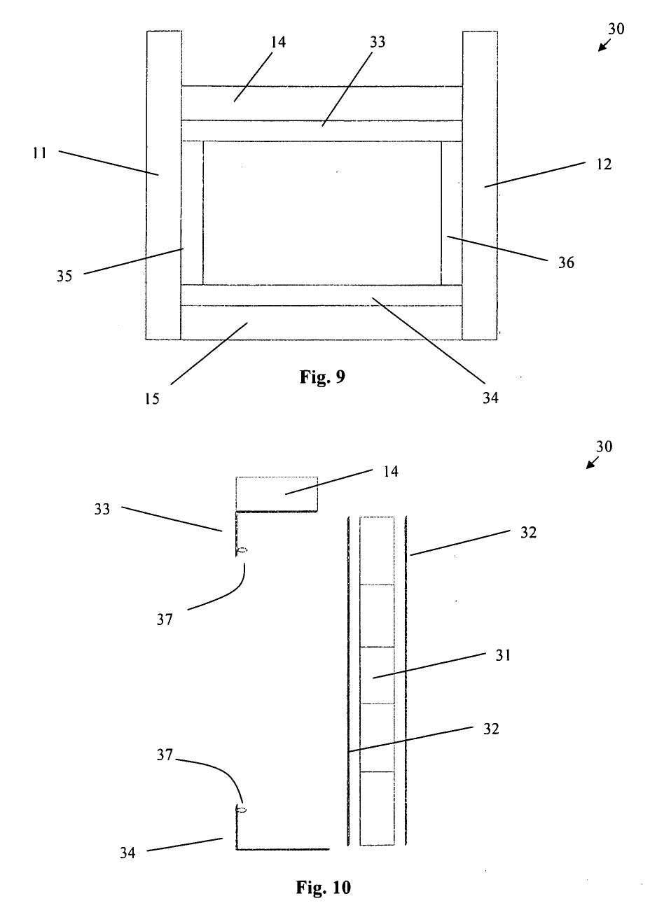

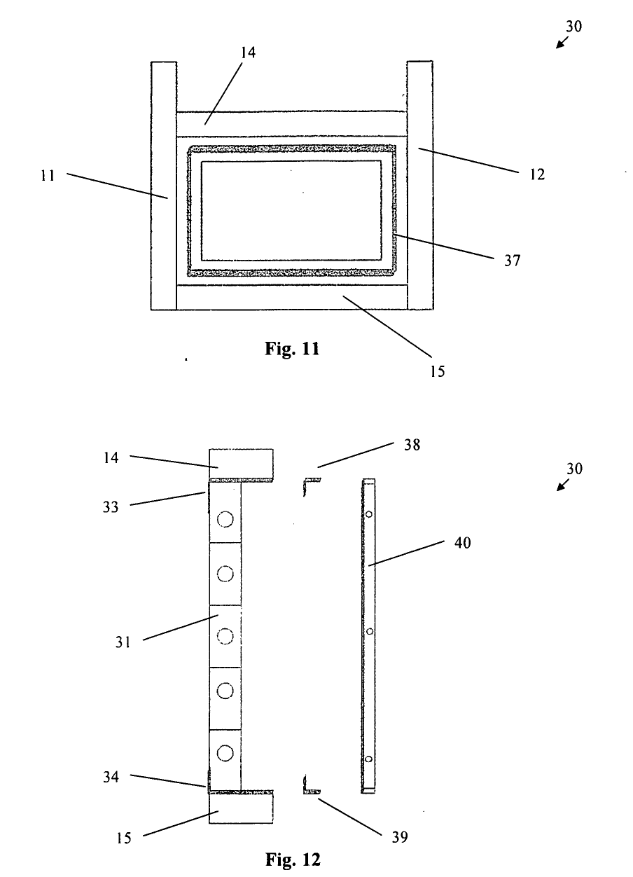

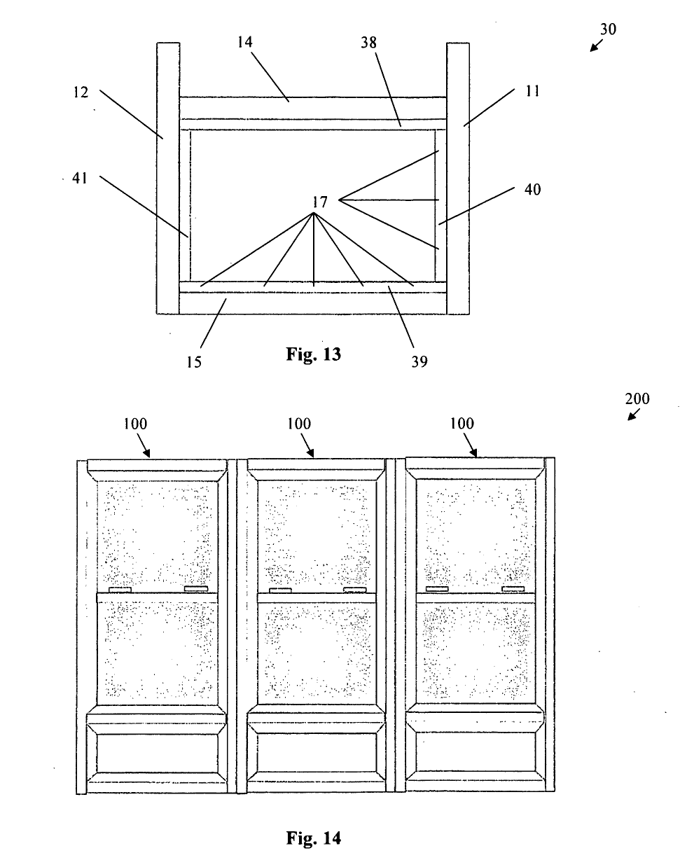

As shown in FIGS. 10-11, to complete the kick plate region 30, a continuous bead of caulk or foam 37 may be deposited about the respective inner surfaces of the top angle 33, a bottom angle 34, a first side angle 35, and a second side angle 36 (see FIGS. 9-11) to create a seal with the stacked cross members 31 and flat coil stock 32 inserted therein. With the plurality stacked cross members 31 disposed within the kick plate region 30 as shown in FIG. 12, a top locking angle 38, a bottom locking angle 39, a first side locking angle 40, and a second side locking angle 41 may be positioned against the rear surface of the plurality of stacked cross members 31 and flat coil stock 32. The locking angles 38-41 may be fixed in position via a plurality of fasteners 17 as shown in FIG. 13. In a preferred embodiment, each of the top angle 33, bottom angle 34, top locking angle 38, and bottom locking angle 39 may be secured in position by five fasteners 17 while each of the first side angle 35, second side angle 36, first side locking angle 40, and second side locking angle 41 may be secured in position by three fasteners 17 to the respective surrounding structures of the frame assembly. In such a manner, the plurality of stacked cross members 31 and one or more flat coil stocks 32 may be securely retained within the kick plate region 30 as generally depicted in FIG. 7.

As shown in FIG. 14, the high impact panels of the present invention may be modular in nature wherein two or more of the high impact panels 100 may be combined to form a high impact wall panel 200 that may be part of an overall high impact system.

### II. High Impact Panel System

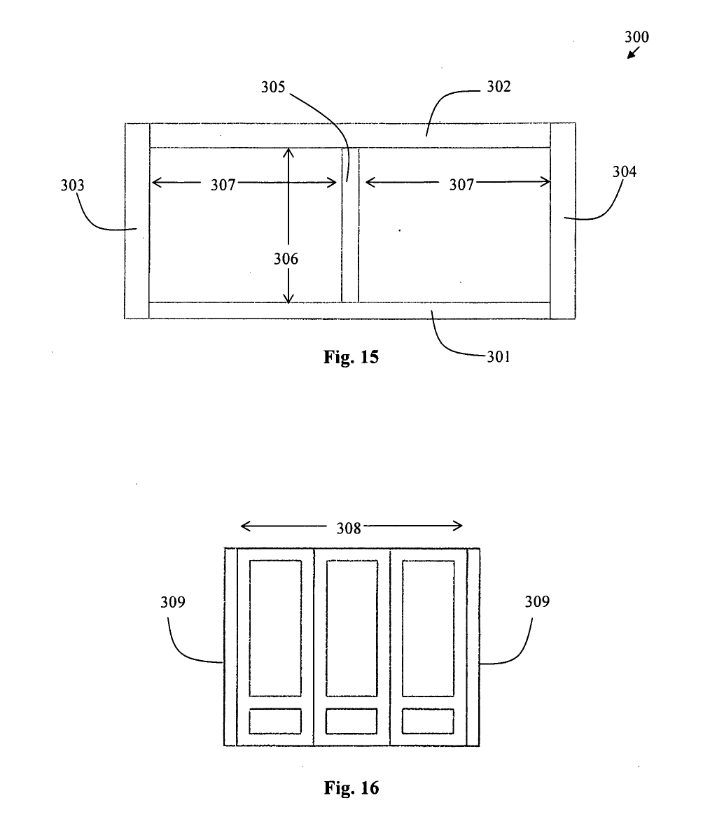

FIG. 15 depicts a conventional opening (e.g. a porch) disposed within a preexisting structure 300. The preexisting structure 300 may comprise a floor 301, a ceiling 302, a first side wall 303, a second side wall 304, and potentially one or more posts 305 if the overall width of the opening requires such reinforcement. The opening may have a height 306 and a width 307 or may have a height 306 and a width 307 for each respective section of the opening between the one or more posts 305, as seen in FIG. 15.

In conventional use, the average opening height 306 is approximately 92 inches and the average opening width 307 is approximately 126 inches. In a preferred embodiment, when a high impact wall panel 200 comprising two or more high impact panels 100 is inserted within the opening, approximately a 1 inch gap will be on each side of the wall panel 200. If such a gap is not present, the approximate 1 inch gap may be formed by combining pre-sized studs with the high impact wall panel 200. If the gap size differs by more than ¾ of an inch, the gap size may be adjusted by adding or removing studs. Studs are available in a variety of widths including but not limited to 2 inch, 3 inch, 4 inch, and 5 inch studs. If the gap size is more than a stud can make up, a half high impact panel may be available to more easily fill the opening and achieve a proper gap.

FIG. 16 illustrates a high impact wall panel 200 to be fitted into the opening of FIG. 15. In such an embodiment, the opening width 307 of FIG. 15 may be 126 inches while the wall panel width 308 may be 120 inches. Such dimensions create a 3 inch gap on each side of the wall panel 200. To provide the desired 1 inch gap on each side of the wall panel 200, a 2 inch stud 309 may be placed on each end of the wall panel 200.

The opening height 306 may be determined on a case by case basis due to the dimensions of the preexisting structure 300. To account for variability in the sizes of opening heights 306, the high impact panels 100 and therefore the high impact wall panels 200 may be provided for in any size height necessary including but not limited to 88 inch heights, 90 inch heights, 92 inch heights, 94 inch heights, and the like.

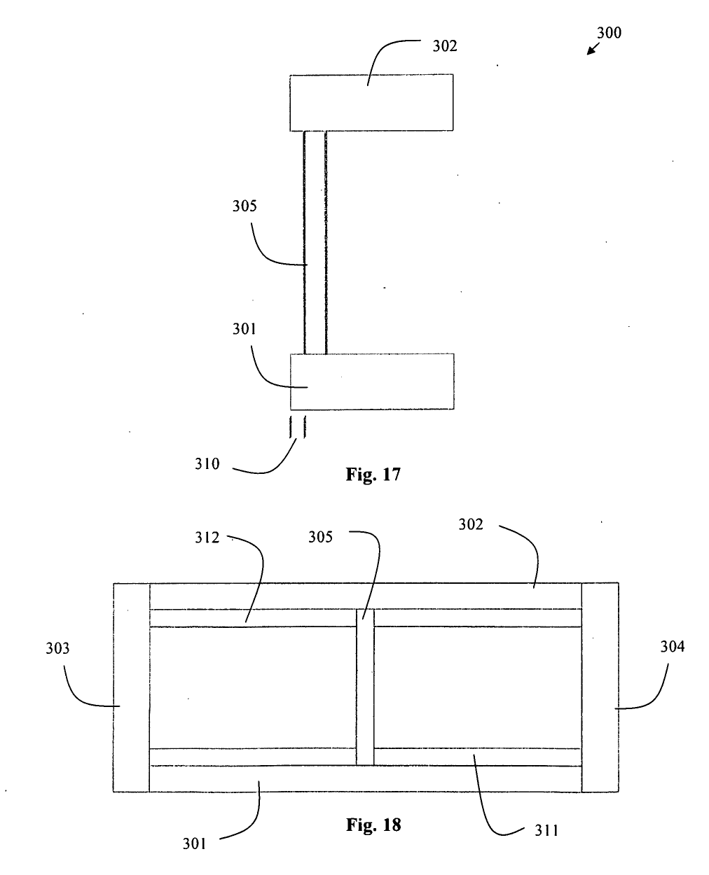

As shown in the side view of FIG. 17, an opening of a preexisting structure 300 may position the one or more posts 305 a specific set back distance 310 from the outer edge of the floor 310 and ceiling 302 of the preexisting structure 300. This set back distance 310 may be used to align the outer surface of any high impact panel 100 or high impact wall panel 200 that may be disposed within the opening of the preexisting structure 300 within the vertical plane of the set back distance 310.

In one embodiment, the first step of installation of the present inventive high impact wall panel system 200 is to remove all materials, fasteners, caulk, loose concrete, loose paint, and the like that may be present in the opening of any preexisting structure 300 being retrofit with the system of the present invention. If the opening is part of a preexisting structure 300 that is new construction, no preparation step may be necessary. The installation process may start from the first side wall 303, and if present, from any of the one or more posts 305 disposed within the opening. The position of the one or more posts 305 will determine the setback distance 310 for the installation process, and if no post 305 is present the set back distance 310 may be 1.5 inches or any other desired distance that may be enforceable by local code while serving to maintain the strength of the system. For ease of illustration, the primary examples given below will pertain to openings in preexisting structures 300 having one center post 305 (as shown in FIG. 18) but the scope of the present invention further includes panels and systems of the present invention constructed in openings of preexisting structures 300 having either no posts or one or more posts 305.

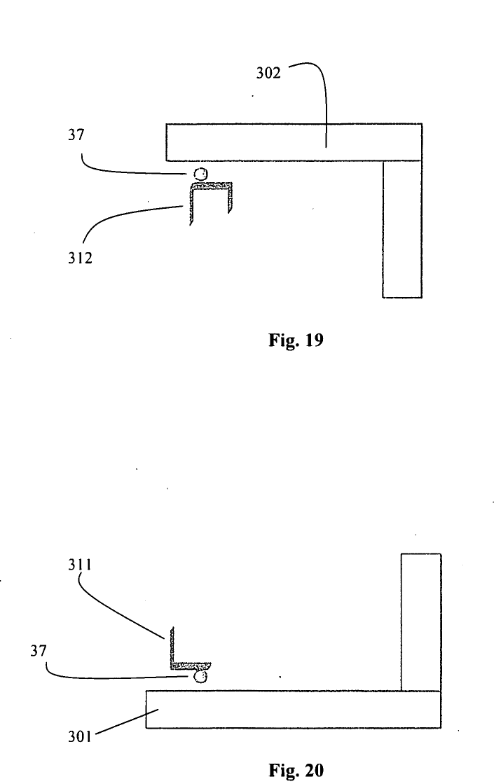

The next step of installation is shown in FIG. 18, wherein a floor angle 311 is cut to fit within the opening width 307 between each of the one or more post 305 and the floor angle 311 is then disposed along the floor 301 within the opening. In the same manner, an upper C-channel 312 is cut to fit the opening width 307 between each of the one or more posts 305 and the upper C-channel 312 is then disposed along the ceiling 302 within the opening. The cutting to fit may be accomplished by any means known within the art including but not limited to cutting with a hacksaw, sawzall, chop saw with a metal blade, and the like. Both the floor angle 311 and the upper C-channel 312 will be position along the selected set back position 310 from the exterior edge of the opening. Prior to fixation at least one continuous bead of caulk 37 or any other sealant known within the art may be placed both along the length of the upper C-channel 312 to create a seal between the upper C-channel 312 and the ceiling 302 of the opening (see FIG. 19) and along the length of the floor angle 311 to create a seal between the floor angle 311 and the floor 301 of the opening (see FIG. 20). The floor angle 311 and upper C-channel 312 may be fixed to the floor 301 and ceiling 302 of the opening, respectively, by any means known within the art including but not limited to fasteners 17 and in a preferred embodiment forming pre-drilled holes into which concrete fasteners are anchored thereby securing the floor angle 311 and upper C-channel 312 in position. The floor angle 311 and upper C-channel 312 may initially be left slightly loose to allow adjustments to be made to the position of the floor angle 311 and upper U-channel 312, respectively. All fasteners and means of fixation are to meet local code requirements and preferably all fasteners and means of fixation will either meet or exceed the more stringent requirements of the Miami Dade high impact specifications.

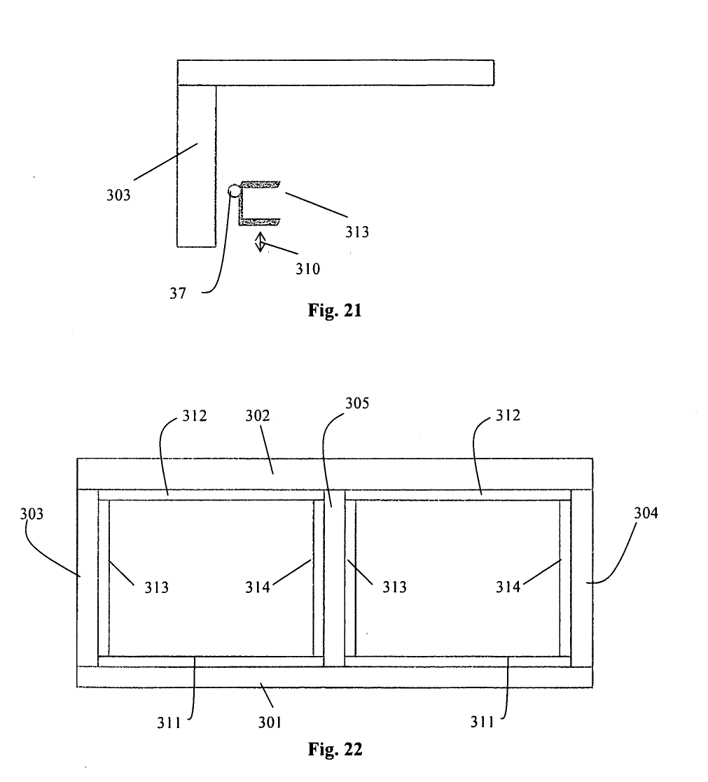

Next, the vertical distance between the floor angle 311 and the upper C-channel 312 may be measured. At least a first side C-channel 313 and a second side C-channel 314 are cut to match the measured vertical distance between the floor angle 311 and upper C-channel 312. The first side C-channel 313 may then be fixed to the first side wall 303 and/or one or more left posts (see FIG. 22) when the opening comprises one or more posts 305. The second side C-channel 314 may then be fixed to the second side wall 304 and/or one or more right posts 305 (see FIG. 22) when the opening comprises one or more posts 305. The side C-channels 313-314 may be secured to the side walls 303-304 or one or more posts 305 in any manner similar to the above-described fixation of the floor angle 311 and the upper C-channel 312 to the floor 301 and ceiling 302, respectively. As shown in FIG. 21 and prior to fixation, the side C-channels 313-314 may be placed at the appropriate set back distance 310 from the exterior edge of the opening. Additionally, at least one continuous bead of caulk 37 or any other sealant known with in the art may be placed both along the length of the respective side C-channels 313-314 to create a seal between the side C-channel 313-314 and a side wall 303-304 or post 305 of the opening.

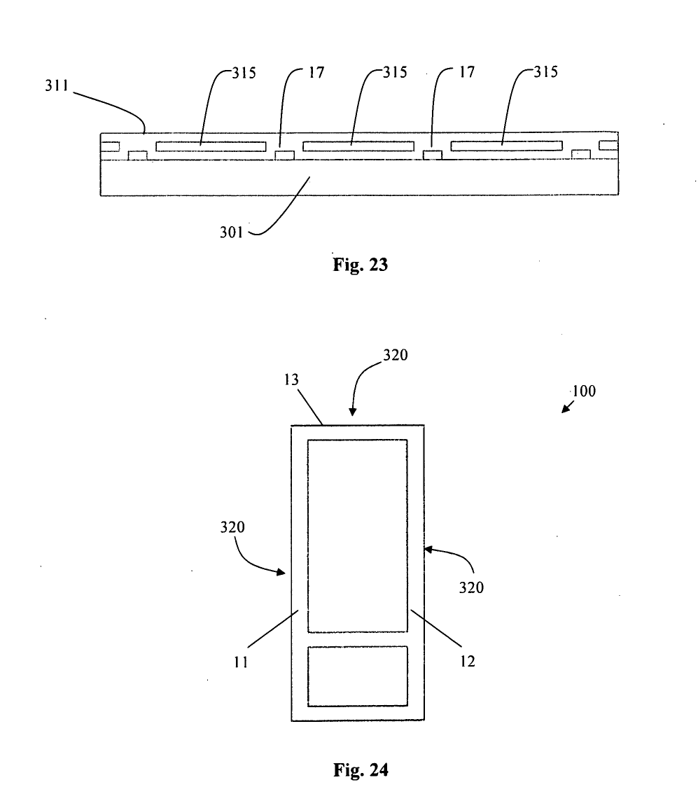

Prior to the installation of one or more high impact panels 100 and as shown in FIG. 23, one or more shims 315 may be disposed between each of the fasteners 17 used to secure the floor angle 311 to the floor 301 of the preexisting structure 300. The one or more shims 315 may allow the one or more high impact panels 100 to slide easily along the floor angle 311 and prevent the panels 100 from contacting the tops of the fasteners 17 or any other means having been used to fix the floor angle 311 in position. At both ends of each floor angle 311, any shim 315 to be positioned at such an end may be cut to properly fit into the shortened space between the fastener 17 and the respective side wall 303-304 or post 305. In a preferred embodiment, the one or more shims 315 are composed of plastic, but the scope of the present invention includes shims 315 composed of any other material known within the art.

Insulation may then be inserted within and along the upper C-channel 312 and the respective side C-channels 313-314. Depending on the intended use of the system of the present invention and the geographic location of the preexisting structure 300, the insertion of insulation may be an optional step in the installation process.

The individual high impact panels 100 may then be prepared for installation into the angles and channels of the present inventive system. As shown in FIG. 24, weather stripping 320 may be disposed along the outer perimeter of the first vertical stud 11, second vertical stud 12, and the first horizontal cross member 13 of the frame assembly 10. The weather stripping 320 may be composed of any materials known within the including but not limited to foam or rubber. In a preferred embodiment of the present invention, the weather stripping 320 disposed upon the outer perimeter of the high impact panel 100 may comprise two or more strips of weather stripping 320 on each of the surfaces of the outer perimeter of the high impact panel 100.

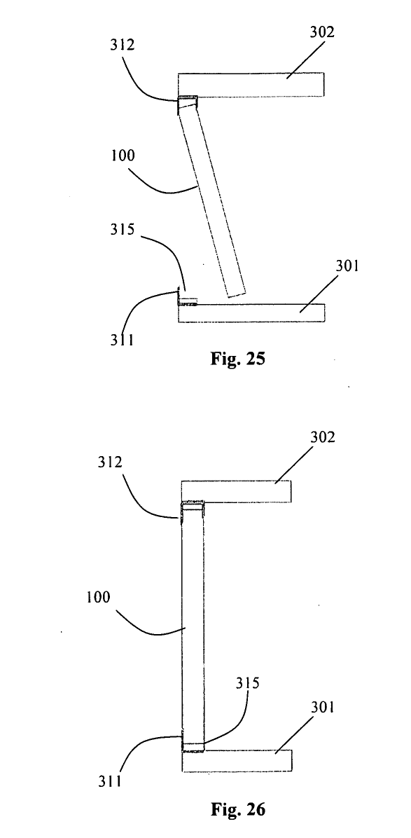

One or more high impact panels 100 of the present invention may now be installed within the angles and C-channels secured about the opening. While holding a high impact panel 100 in a vertical position within the opening and behind the installed floor angle 311 and clear of the side C-channels 313-314, the top edge of the high impact panel 100 (i.e. the first horizontal cross member 13) may be leaned towards the upper C-channel 312 as illustrated in FIG. 25. As shown in FIG. 26, the top edge of the high impact panel 100 may then be inserted into the upper C-channel 312 and the bottom edge of the high impact panel 100 (i.e. the third horizontal cross member 15) may be advanced onto the one or more shims 315 and made to abut the vertical portion of the floor angle 311.

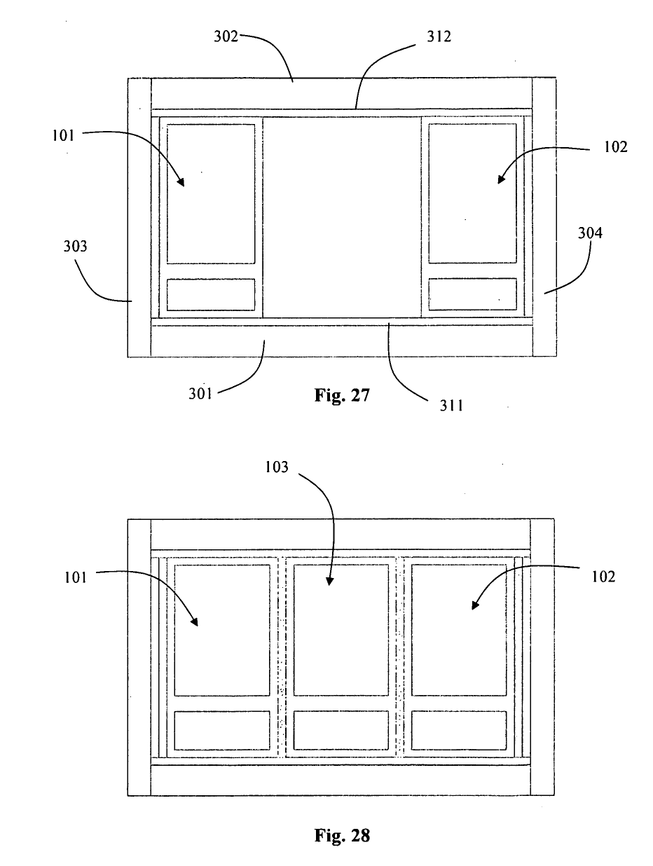

After a first high impact panel 101 has been installed into the upper C-channel 312 and the floor angle 311, the first high impact panel 101 may be slid to either side of the opening while the first panel 101 remains within the upper C-channel 312. As described above, a second high impact panel 102 may also then be installed into the upper C-channel 312 and floor angle 311 of the opening. As depicted in FIG. 27, the second high impact panel 102 may then be slid in a direction opposite of the first high impact panel 101. Sliding the installed high impact panels 101-102 to opposing sides of the opening, preferably until each panel 101-102 contacts the fasteners 17 within the respective side C-channels 313-314, provides a central opening for installation of additional high impact panels 100 into the opening. As shown in the three panel embodiment of FIGS. 27-28, a central high impact panel 103 may then be disposed within the upper C-channel 312 and the floor angle 311 in a position between and sharing the same plane with the first high impact panel 101 and the second high impact panel 102. The central high impact panel may also comprise one or more strips of weather stripping 320 disposed about its upper and side perimeter.

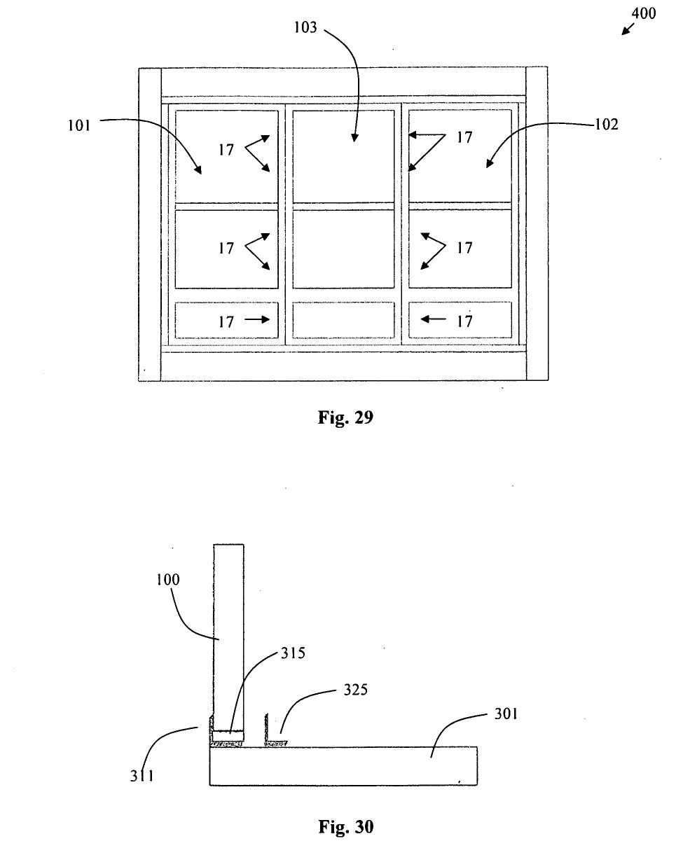

The first high impact panel 101 and second high impact panel 102 may then be moved medially toward the center of the opening and positioned to abut the central high impact panel 103. As the panels 101-102 are moved (see FIGS. 28-29), the panels 101-103 are preferably positioned such that the side apertures at the first side wall 303 and second side wall 304 are equal in size on both sides of the three abutting high impact panels 101-103. If the embodiment utilizes insulation between the high impact panels 101-103, the insulation may then be allowed to expand and function properly within the system of the present invention.

The three abutting high impact panels may then be secured together to create a structured wall or unified high impact wall panel 400. As shown in FIG. 29, a plurality of fasteners 17 may be used at one or more locations between both the first high impact panel 101 and the central high impact panel 103 to secure these panels 101,103 together as well as between the second high impact panel 102 and the central high impact panel 103 to also secure these panels 102,103 together. Such points of connection act to create a structured wall or unified high impact wall panel 400.

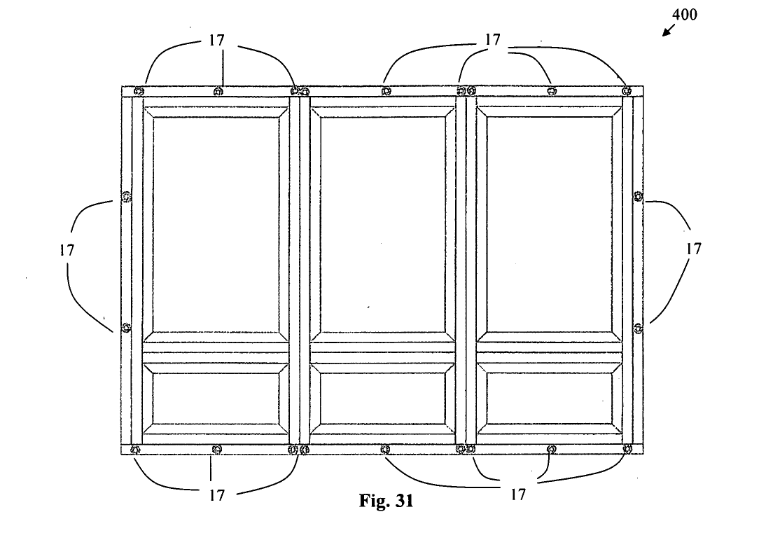

With the high impact wall panel 400 configured, the wall panel 400 may then be secured in place. As shown in FIG. 30, a locking angle 325 may be abutted against each of the respective high impact panels 101-103 that comprise the high impact wall panel 400. In a preferred embodiment, the locking angle 325 may comprise a right angle cross section providing a first attachment surface parallel to the floor 301 of the preexisting structure 300 and a second attachment surface parallel to and directly abutting the rear plane of the high impact wall panel 400. Such a locking angle 325 acts to secure the high impact wall panel 400 in position and prevent removal of the high impact wall panel 400 if one attempts to reverse the installation steps. One or more fasteners 17 may be used to secure both the first attachment surface of the locking angle 325 to the floor 301 and the second attachment surface to the rear surface of the high impact wall panel 400. The fasteners 17 may comprise any fixation means known with the art including but not limited to concrete fasteners for attachment to the floor 301 and stainless steel screws for attachment to the high impact wall panel 400. To facilitate the installation process, the locking angle 325 may have pre-drilled holes disposed through one or both of its two perpendicular attachment surfaces to assist in securing the locking angle 325 to the floor 310 and/or high impact wall panel 400. In a preferred embodiment, the fasteners 17 used for attaching the locking angle 325 to the floor 301 may be drilled and/or angled into the floor 301 at an angle directed towards the high impact wall panel 400. Such an angled insertion of the fasteners 17 for the floor 301 serves to tighten the locking angle 325 to the wall panel 400 and further lock the high impact wall panel 400 into position.

Finally as shown in FIG. 31, a plurality of fasteners 17 may be disposed through the upper C-channel 312, the first and second side C-channels 313-314, and floor angle 311 as a method of securing the outer framework attached to the opening to the high impact wall panel 400. Such connection to the high impact wall panel 400 may be made along the respective first horizontal cross members 13, the first and second vertical studs 11-12, and the third horizontal cross members 15. In a preferred embodiment, the fasteners 17 for this purpose may comprise self-tapping rubber washer screws, but such fasteners 17 may comprises any form of equivalent fasteners known within the art.

As needed, a hinged door panel may replace one of the high impact panels 100 of the high impact wall panel to provide user access through the high impact wall panel system, such as when entering and exiting a porch that is protected by the system of the present invention system.

### III. High Impact Panel System for Forming New Housing

In still another embodiment of the present invention, a temporary housing unit may be assembled in one day for use in disaster areas or anytime immediate temporary housing is needed. The present inventive high impact wall panel system may provide a well-constructed housing unit that has the ability to be disassembled and used again. Reusable temporary housing could save hundreds of thousands of dollars and put people in sturdy high impact homes instead of inefficient travel trailers. Most trailers that are used for temporary housing were not made for extended living and cannot withstand long-term inhabitants. After a short period of time, the construction of such trailers cannot hold up to the rigors of constant family living. Most of these trailers are then auctioned off at 80% to 90% off their initial value or may even be disposed of as a total loss. The present inventive temporary housing comprising two or more high impact wall panels is reusable thereby retaining its lasting value. The present inventive temporary housing units are constructed to possess strength and durability and are capable of disassembly just as quickly as they may be assembled.

In one embodiment, high impact wall panel systems of the present invention may be assembled and combined on a structured floor and also have a structured roof system attached to create a totally enclosed high impact housing unit.

Making the transition from a basic high impact wall panel to a high impact housing panel takes no great leaps in engineering. Different high impact housing panels may be manufactured for their specific intended applications. A “no window” panel may be formed to accept an HVAC unit, instant-on hot water, and/or a main breaker panel to supply electricity. The high impact housing panels may generally be assembled in the same manner as described above regarding high impact wall panels. An optional jig may still be used to construct the high impact housing panels after an easy modification. The construction process may be the same procedure as followed with the high impact panel. In one difference, a post (preferably a 3 inch by 3 inch) will be used at the corners of the high impact housing unit and in any walls that are equal to or greater than 10 feet. Such posts and/or beams frame an opening in the skeletal preexisting structure within which the high impact housing panels may disposed. A hinged door may be inserted within any panel section thereby completing the high impact housing structure. The roof and floor systems may also comprise high impact housing panel systems having a similar assembly process and may also come in modular panels and sections for quick assembly of the entire high impact structure.

A high impact structure having a simple floor plan and simple electrical and plumbing systems may be factory constructed and immediately ready for quick and easy installation as needed. Customizations to such high impact housing structures may be easily made thereby allowing for the high impact housing structures to adapt to any special applications or unforeseen conditions that may arise. Such general manufacturing and/or adaptations may be done either in the factory or on-site, including all construction or modification to floor layouts, electrical systems, and/or plumbing systems. The present inventive high impact housing panels may be pre-manufactured and stored in an easy to build kit allowing for rapid deployment of such high impact housing structures during times of natural disaster and the like where availability of temporary housing may be critical.

Accordingly the reader will see that, according to the various embodiments of the invention, the present invention provides for a high impact panel, a high impact wall panel system comprising one or more interconnected high impact panels for protecting an opening of a building or other structure, and a high impact housing panel system comprising one or more interconnected high impact housing panels for forming temporary housing and the like.

While the above description contains much specificity, these should not be construed as limitations on the scope of any embodiment, but as exemplifications of the presently preferred embodiments thereof. Many other ramifications and variations are possible within the teachings of the various embodiments.

Thus the scope of the invention should be determined by the appended claims and their legal equivalents, and not by the examples given.

What is claimed is:

1. A high impact panel system for protecting an opening within a structure comprising:
an upper C-channel attached to said structure along the upper surface of said opening;
a floor angle attached to said structure along the lower surface of said opening;
at least one high impact panel, wherein an upper end of said at least one high impact panel is inserted within said upper C-channel and a lower end of said at least one high impact panel abuts said floor angle; and
a locking angle attached to said structure along said lower surface of said opening and abutting against said lower end of said at least one high impact panel, wherein said locking angle retains said lower end of said at least one high impact panel between said floor angle and said locking angle.

2. The high impact panel system of claim 1 further comprising:
two side C-channels attached to said structure along opposing side edges of said opening, wherein each of said two side C-channels is sized to received a side edge of said at least one high impact panel.

3. The high impact panel system of claim 1, wherein said at least one high impact panel is slidable within said upper C-channel and between said floor angle and said locking angle.

4. The high impact panel system of claim 1, wherein said at least one high impact panel comprises two or more high impact panels, wherein said two or more high impact panels are attached to each adjacent high impact panel via a plurality of fasteners.

5. The high impact panel system of claim 1, wherein said floor angle and said locking angle comprise right angle brackets each having a first attachment surface parallel to the adjacent said at least one high impact panel and a second attachment surface parallel to the adjacent said lower surface of said opening wherein said second attachment surface of said floor angle extends under said lower end of said at least one high impact panel and said second attachment surface of said locking angle extends away from said at least one high impact panel.

6. The high impact panel system of claim 1, wherein said at least one high impact panel comprises:
a first vertical stud;
a second vertical stud spaced apart from and disposed parallel to said first vertical stud;
a first horizontal cross member connecting a top end of said first vertical stud to a top end of said second vertical stud;
a second horizontal cross member connecting said first vertical stud to said second vertical stud between said upper end and a lower end of each of said first vertical stud and said second vertical stud;
a third horizontal cross member connecting said lower end of said first vertical stud to said lower end of said second vertical stud.

7. The high impact panel system of claim 6, wherein a window opening is disposed between said first horizontal cross member and said second horizontal cross member.

8. The high impact panel system of claim 6, wherein a kick plate region is disposed between said second horizontal cross member and said third horizontal cross member.

9. The high impact panel system of claim 1, wherein said kick plate region comprises a plurality of stacked cross members.

10. The high impact panel system of claim 9, wherein the exposed surfaces of said plurality of stacked cross members of said kick plate region are covered by one or more pieces of flat coil stock.

11. The high impact panel system of claim 1 further comprising:
one or more shims disposed between said second attachment surface of said floor angle and said lower end of said at least one high impact panel.

12. A high impact panel system for protecting an opening within a structure comprising:
an upper C-channel attached to said structure along the upper surface of said opening;
a floor angle attached to said structure along the lower surface of said opening;
at least one high impact panel, wherein an upper end of said at least one high impact panel is inserted within said upper C-channel and a lower end of said at least one high impact panel abuts said floor angle;
two side C-channels attached to said structure along opposing side edges of said opening, wherein each of said two side C-channels is sized to received a side edge of said at least one high impact panel;
a locking angle attached to said structure along said lower surface of said opening and abutting against said lower end of said at least one high impact panel, wherein said locking angle retains said lower end of said at least one high impact panel between said floor angle and said locking angle; and
one or more shims disposed between said floor angle and said lower end of said at least one high impact panel;
wherein said at least one high impact panel is slidable within said upper C-channel and between said floor angle and said locking angle;
wherein said at least one high impact panel is attached to each adjacent high impact panel via a plurality of fasteners;
wherein said floor angle and said locking angle comprise right angle brackets each having a first attachment surface parallel to the adjacent said at least one high impact panel and a second attachment surface parallel to the adjacent said lower surface of said opening wherein said second attachment surface of said floor angle extends under said lower end of said at least one high impact panel and said second attachment surface of said locking angle extends away from said at least one high impact panel.

13. A method of protecting an opening within a structure comprising the steps of:
attaching an upper C-channel to said structure along the upper surface of said opening;
attaching a floor angle to said structure along the lower surface of said opening;
inserting an upper end of at least one high impact panel within said upper C-channel;
pivoting said upper end of said at least one high impact panel within said upper C-channel wherein a lower end of said at least one high impact panel abuts said floor angle; and
attaching a locking angle to said structure along said lower surface of said opening and abutting against said lower end of said at least one high impact panel, wherein said locking angle retains said lower end of said at least one high impact panel between said floor angle and said locking angle.

14. The method of claim 13, wherein said at least one high impact panel comprises:
a first vertical stud;
a second vertical stud spaced apart from and disposed parallel to said first vertical stud;
a first horizontal cross member connecting a top end of said first vertical stud to a top end of said second vertical stud;
a second horizontal cross member connecting said first vertical stud to said second vertical stud between said upper end and a lower end of each of said first vertical stud and said second vertical stud;
a third horizontal cross member connecting said lower end of said first vertical stud to said lower end of said second vertical stud.

15. The method of claim 14, wherein a window opening is disposed between said first horizontal cross member and said second horizontal cross member.

16. The method of claim 14, wherein a kick plate region is disposed between said second horizontal cross member and said third horizontal cross member.

17. The method of claim 13, wherein said floor angle and said locking angle comprise right angle brackets each having a first attachment surface parallel to the adjacent said at least one high impact panel and a second attachment surface parallel to the adjacent said lower surface of said opening wherein said second attachment surface of said floor angle extends under said lower end of said at least one high impact panel and said second attachment surface of said locking angle extends away from said at least one high impact panel.

18. The method of claim 13, wherein said at least one high impact panel comprises two or more high impact panels, wherein each of said two or more high impact panels is attached to at least one adjacent high impact panel.

19. The method of claim 13, further comprising the step of:
attaching two side C-channels along opposing side edges of said opening, wherein each of said two side C-channels is sized to received a side edge of said at least one high impact panel.

20. The method of claim 13, wherein said at least one high impact panel is slidable within said upper C-channel and between said floor angle and said locking angle.
